(19) United States
(12) Patent Application Publication
(10) Pub. No.: US 2017/0193522 A1
(43) Pub. Date: Jul. 6, 2017

(54) METHOD, SERVER AND SYSTEM FOR DYNAMIC CUSTOMER/PROVIDER DATA PAIRING

(71) Applicants: Sophia Hui Hui HO, Singapore (SG); Timothy Siew Wing WONG, Singapore (SG)

(72) Inventors: Sophia Hui Hui HO, Singapore (SG); Timothy Siew Wing WONG, Singapore (SG)

(21) Appl. No.: 15/313,002

(22) PCT Filed: May 25, 2015
(86) PCT No.: PCT/SG2015/050124

§ 371 Date: Nov. 21, 2016

(30) Foreign Application Priority Data
May 23, 2014 (SG) 10201402605Y

(51) Int. Cl. G06Q 30/00

(52) U.S. Cl. CPC G06Q 30/016; G06Q 30/012

(57) ABSTRACT

Methods, servers and systems for dynamic customer/provider data pairing are provided. One of the methods comprises receiving one or more sets of data from a customer; processing the one or more sets of data from the customer, wherein the one or more sets of data is each dynamically assigned with category information, and wherein the processing comprises saving the one or more sets of data along with the corresponding assigned category information in a server; forwarding the one or more sets of data to one more providers that are registered under an assigned category corresponding to the assigned category information; and responding to the customer with other one or more sets of data from the one or more providers. The associated servers and systems are also provided.

### PRIORITY CLAIM

The present application claims priority from Singapore application no. 10201402605Y filed on 23 May 2014.

### TECHNICAL FIELD

The following generally discloses method, server and system arrangements for dynamic customer/provider data pairing.

### BACKGROUND ART

Product and service providers have traditionally used similar techniques in the customer engagement processes. For example, a potential customer who wishes to purchase a product would have to source for it from a retail/online shop to another, comparing purchase packages (such as does it include delivery and installation charges) as well as after-sales service, or after service supports (such as how many years of warranty, and what are the free of charge replacement parts included in the service packages of the warranty et cetera). Once the potential customer has decided to purchase a particular model of the product, the warranty card of the purchased product has to be submitted through snail mail or online warranty registration within a stipulated period from the date of purchase/delivery.

Another example, whereby another customer whose product either purchased or loaned does not have a warranty, a one time service payment would be required. Alternatively, the customer could also sign a service contract agreement that would either cover product breakdown for a period of time or provide a selection of after-sales services (after services).

Subsequently, if the product has issue(s), the traditional service engagement techniques, would require the customer to make an effort to call the customer service hotline for service(s) or by keying in the service request information for online submission. These traditional techniques, however, do have their shortcomings.

For instance, a potential customer who wishes to purchase a typical type of product would first of all have to locate retail source selling the product. The customer would have to visit one physical location to another for retail sourcing, and one URL (Universal Resource Locator) to another for online sourcing. Furthermore, once the product is purchased, in order to receive the warranty protection, the customer would have to send the warranty card through snail mail or through online warranty registration,

Sending the warranty card via either snail mail or online registration would inconvenience the customer as both methods would require the presentation of an original receipt/warranty card when service is required. By the time of service, the original receipt/warranty card could be misplaced or lost. Likewise, the traditional practice of sending the signed service contract agreement through snail mail or in person has the same issues.

Other shortcomings for traditional service engagement practices, include dependence on the customer service's phone line availability (if the customer opted to call for service(s)). Furthermore, for online submission, though not affected by the customer service's phone line availability, both methods require the customer to have knowledge of technical jargon (in order to narrate the issue(s) or event(s) to the customer service) which may not be possible. In addition, the traditional service engagement techniques would require the customer to know the customer service's phone line number for calling the respective service provider and the URL (Universal Resource Locator) for online service engagement submission.

Thus, what is needed are methods, servers and systems that are configured to address the above shortcomings of the conventional customer purchase engagement and service engagement. Furthermore, other desirable features and characteristics will become apparent from the subsequent detailed description and the appended claims, taken in conjunction with the accompanying drawings and this background of the disclosure.

### SUMMARY OF INVENTION

Disclosed are methods, servers, and systems for dynamic customer/provider data pairing to improve the customer engagement process, right from sourcing product(s) and/or service(s) and maintaining a response list for the product(s) and/or service(s) from one or more vendors, to facilitate purchase, delivery, warranty/service agreement registration, service request engagement and feedback. In the present application, the provider can be a vendor who sells products and/or provides or arranges services, a manufacture of products, or a service provider.

According to a first aspect of the present invention, there is provided a method for dynamic customer/provider data pairing. The method comprises receiving one or more sets of data from a customer, processing the one or more sets of data from the customer, wherein the one or more sets of data is each dynamically assigned with category information, and wherein the processing comprises saving the one or more sets of data along with the corresponding assigned category information in a server, forwarding the one or more sets of data to one or more providers that are registered under an assigned category corresponding to the assigned category information; and responding to the customer with other one or more sets of data from the one or more providers.

According to a second aspect of the present invention, there is provided a server for an intermediary that transmits one or more data between customers and providers, the one or more data was assigned with a category information enabling dynamic customer/provider data pairing. The intermediary server comprises at least one processor and at least one memory including computer program code. The at least one memory and the computer program code is configured to, with the at least one processor, cause the intermediary server at least to receive one or more sets of data from a customer and process the one or more sets of data from the customer. The one or more sets of data is each dynamically assigned with category information. The processing comprises saving the one or more sets of data along with the corresponding category information. The at least one memory and the computer program code is configured to, with the at least one processor, further cause the intermediary server at least to forward the one or more sets of data to one or more providers that are registered under an assigned category corresponding to the assigned category information and respond to the customer with other one or more sets of data from the one or more providers.

According to a third aspect of the present invention, there is provided a system for customer warranty management and after service support. The system comprises a server for an intermediary that transmits data between one or more customers and one or more providers, and stores data received as one or more sets of data from the one or more customers; one or more customer apparatus for the one or more customers to send the one or more sets of data to the server, wherein the one or more sets of data comprise customer warranty information; and one or more provider apparatus for of the one or more providers to receive the one or more sets of data and respond to the server with other one or more sets of data. The one or more sets of data further comprise after service requests in relation to one or more products or services, wherein the server checks the customer warranty information and service provider information registered in the server under the customer for pairing with the one or more products or services. When the one or more products or services are not paired with one or more registered warranty information and service provider information, the server dynamically assigns category information to the after service request and saves the one or more sets of data of the after service request along with the corresponding assigned category information, the server forwards the one or more sets of data to one or more providers that are registered under an assigned category corresponding to the assigned category information, and the one or more providers respond to the one or more customer via the server. When the one or more products or services are paired with one or more registered warranty information and service provider information, the after service request is within the validity period of the registered warranty, the server forwards the one or more sets of data of the after service request to the one or more registered service provider, and the one or more registered service provider respond to the one or more customer with the other one or more sets of data of the after service request via the server.

For example, a potential customer has a type of furniture in mind, and would wish to source for the type of furniture from any possible vendor that has the category of furniture. Instead of visiting one physical location to another for retail sourcing and one URL (Universal Resource Locator) to another for online sourcing, the potential customer could draft the design and feature of that furniture, capture the draft's image(s) with an apparatus's camera function, and use the disclosed system to broadcast the draft's image(s) to the various vendors that has that category of furniture.

For interested vendors that have similar furniture in design and feature, they could respond to the potential customer enquiry by posting images of their similar furnitures with additional comments (such as price and specification et cetera). The potential customer could choose to respond to one or more vendors that have responded to the enquiry. Once the potential customer has accepted the deal from one or more vendors, the potential customer could proceed to the mode of payment (such as by credit, nets, or cash upon delivery) and arrangement for delivery.

In one embodiment, the disclosed system is described as capable of categorizing the vendor, and a vendor can be in one or more categories. For example, a superstore can be in the furniture category, as well as grocery category and computer category. A potential customer who wishes to buy a computer of a particular brand can broadcast the model via the disclosed server to one or more vendors that are registered under an assigned category corresponding to the assigned category information, e.g. the furniture category or from any vendor that is not registered under an assigned category corresponding to the assigned category information, e.g. the furniture category, the superstore that is also in the computer category, could also respond to the customer enquiry, beside other smaller computer shops who are also capable of responding via the disclosed system. The potential customer, receiving the responds from the various vendors, can decide which vendor(s) to continue with the conversation.

In another embodiment, the customer can choose a particular vendor for product(s) and/or service(s) enquiries that is on lease or purchased. The vendor can opt to reject respond or respond and offer a deal. The customer can opt to reject or accept the deal. If the deal is accepted by both parties, the customer could select the deal and proceed to the mode of payment and delivery arrangement, follow by the customer decision whether to close the enquiry with selectable options after the mode of payment or delivery arrangement.

The customer would receive payment confirmation, delivery and warranty acceptance respond requests from the vendor to the customer's apparatus (such as portable device, personal computer et cetera).

Upon delivery of product to the customer premise, the customer could inspect the product and opt to accept or reject the product through the delivery acceptance respond request send by the vendor to the customer's apparatus. The customer could input a comment for the product delivery acceptance or rejection.

Within specific number of days, from the acceptance of the delivery, the customer could submit the warranty through the warranty submission/registration respond request via the customer's apparatus. The product information and warranty/service agreement information have been provided by the vendor to the system while the customer information has been registered in the system. For example, the specific number of days is seven or any of the terms agreed upon between the customer and the provider.

For Manufacturers and their Service Provider that prefer the traditional technique of warranty submission. The customer can capture image of the signed and inputted warranty card and submit through the customer's apparatus.

Likewise, for signed Service Contract's image captured could also be submitted through the customer's apparatus.

Alternatively, the warranty/service agreement information such as terms and conditions can be pre-uploaded in terms of words to and stored in the server by the Provider. The terms and conditions can be tied to a product/service, such that when any customer establishes a transaction to purchase this product/service, the information of terms and conditions that stored in the server will be dynamically paired to the product/service being purchased in the transaction. This dynamic pairing could drastically reduce the processing of warranty/service agreement.

In one embodiment, the present application allows customer to select Service Provider(s) for Service Request engagement. Image(s) and/or video(s) are captured and send with the customer's apparatus to the Service Provider of the product/service. This would avoid the requirement on the customer to have strong command of language and knowledge of technical jargon, in order to narrate the issue(s) or event(s), and would allow the Service Provider of the product/service to have an exact understanding of the issue(s) or event(s), in order to execute the correct and relevant service procedure.

In another embodiment, the captured image(s) or video(s) can be in a form of image code which identifies the product/service's brand, model and serial number that would pair with the terms and conditions of the product/server pre-uploaded to the server by the provider plus purchase evidence, such as receipt. The provider could be one or more of manufacturers, vendors or service providers.

In the present application, the server can be in a flexible configuration. For example, it can be a remote server or a cloud server.

### BRIEF DESCRIPTION OF DRAWINGS

In order to describe the manner in which the above recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which.

FIG. 1 shows an overview of the present application.

FIG. 2 shows an overview of a customer's perspective from use of the present application.

FIG. 3 shows an overview of a service/product provider's perspective from use of the present application.

FIG. 4 shows an overview of a system administrator's perspective from use of the present application.

FIG. 5 depicts a first usage scenario of the present application.

FIG. 6 depicts a second usage scenario of the present application.

FIG. 7 depicts a third usage scenario of the present application.

FIG. 8 depicts a fourth usage scenario of the present application.

FIG. 9 depicts a fifth usage scenario of the present application.

Skilled artisans will appreciate that elements in the figures are illustrated for simplicity and clarity and have not necessarily been depicted to scale. For example, the dimensions of some of the elements in the illustrations, block diagrams or flowcharts may be exaggerated in respect to other elements to help to improve understanding of the present embodiments.

### DESCRIPTION OF EMBODIMENTS

Various embodiments of the disclosure are discussed in detail below. While specific implementations are discussed, it should be understood that this is done for illustration purpose only. A person skilled in the relevant art will recognize that other components and configurations may be used without parting from the spirit and scope of the disclosure. Additional features and advantages of the disclosure will be set forth in the description which follows, and in part will be obvious from the description or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by practice of the principles set forth herein.

The present invention relates to Product and Service communication system, and more specifically, to techniques and systems for improving the Customer Engagement processes from Product Enquiry to Service Delivery.

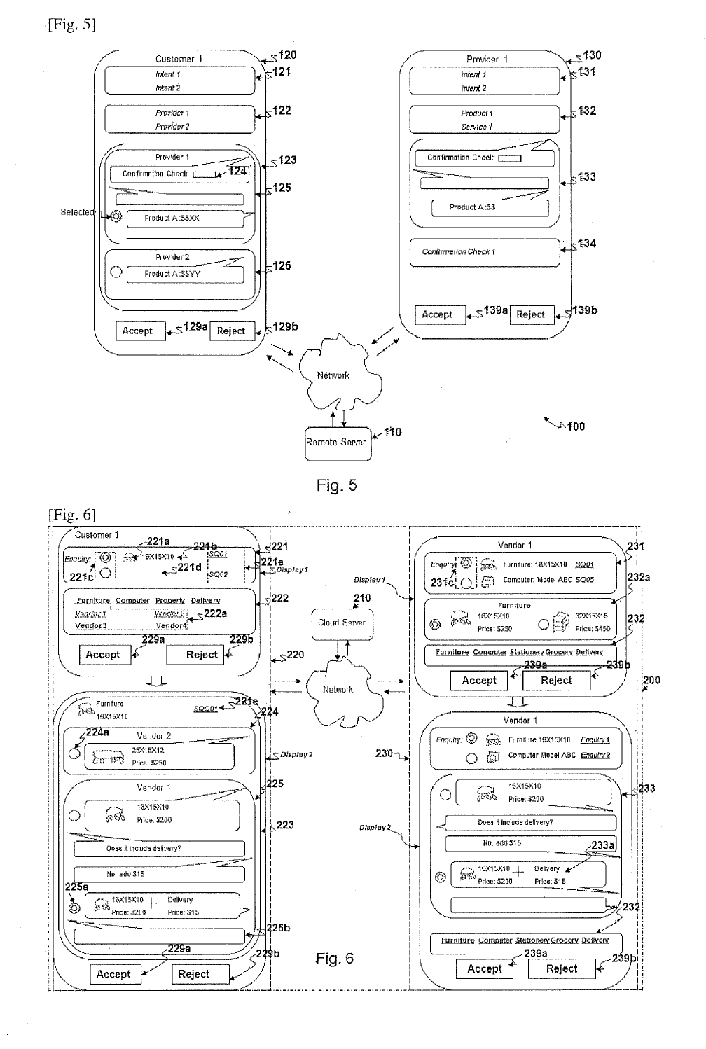

Referencing to FIG. 5, an exemplary system 100 includes server(s) 110 with processing unit(s), RAM(s), ROM, caches and Storage Device(s) to enable the interaction and transaction between the customer's apparatus 120 and the vendor/service provider's apparatus 130.

The apparatuses (120, 130) can be any devices, such as portable smart phone, tablet, laptop or computer that is used by the customer and vendor/service provider, for the disclosed system, to provide dynamic customer/provider data pairing and improved Customer Engagement processes from Product Enquiry to Service Delivery.

A vendor can be manufacturer, supplier, dealer, retailer, contractor, food seller, agency or any other type of vendor where product(s) (including asset(s)) and/or service(s) are been sold or leased. Each vendor can include categorizing lists of product(s) and/or service(s) available in the past and present. Potential customer interested in the product(s) and/or service(s) can make enquiry with references to the categories. Vendors that have the category of product(s) and/or service(s) could respond to the potential customer enquiry.

A Service Provider can be manufacturer, dealer, service partner, contractor or any other type of Service Provider, as long as they are providing some form of servicing (including product and asset servicing) to the customer.

For the ease of explaining, Vendor(s) and Service Provider(s) can be generally referred to as Provider(s).

Apparatus 120 is used by the customer to communicate with the Vendor/Service Provider. In one implementation, the engagement information can be send in one or more intents from the Customer's Apparatus 120 to the Vendor/Service Provider's Apparatus 130 via remote cloud computing server(s) 110. In another implementation, the engagement information in one or more intents can be stored in the remote cloud computing server(s) 110, and be accessible by the server for the viewing and retrieval of the information, required remote accessing through the cloud computing server(s) 110.

In FIG. 5, various sections of the disclosed system are shown and used by the customer from Apparatus 120 to communicate and engaged with the Vendor(s)/Service Provider(s).

Section of Customer Intent 121, is the selectable section that indicate what is the various options of Intent that the customer could communicate and engaged with the Vendor(s)/Service Provider(s). The intent could be an Enquiry to establish a transaction in respect of a product or a service, or a warranty request in respect of a product or a service. The service comprises Warranty/Service Agreement Registration, Service Request, Feedback, or any other Intent that the customer would like to find out and/or required action from the Vendor(s)/Service Provider(s). In this section of Customer Intent 121, the customer can choose what type of Intent to be created and communicated to the Vendor(s)/Service Provider(s).

The intent, in the form of one or more sets of data, can be created and send by the customer in the form of image(s), video(s), comment(s) or a combination of image(s) and/or video(s) with optional comment(s). The one or more sets of data may comprise information comprising one or more of prices, delivery term, service term, warranty term and/or extended service/warranty term. For example, the one or more sets of data is an enquiry to find out whether vendor sells a certain form or design of product, such as a certain design of furniture or art piece.

Restriction can be set on the type of intent, for example, Warranty Registration could only allow image(s), so that OCR (Optical Character Recognition) conversion can take place, and the converted information can be stored in the remote server 110.

In the section of Customer intent 121, one or more sets of data of the various types of intent(s) can be created. The one or more sets of data are each dynamically assigned with category information, with selectable options to add, delete, edit, send and resend any intent(s). The category information is established in the server and selectable by the customer, or is created by the customer.

The one or more sets of data, including the assigned category information, sent by the customer, are received by the server. The server will save the one or more sets of data along with the corresponding assigned category information in the server. The server will also forward the received the one or more sets of data along with the corresponding assigned category information to one or more providers that are registered under an assigned category corresponding to the assigned category information.

Section of Provider 122, is the section that can includes uncategorized or categorized Vendor(s) and/or Service Provider(s) selectable for interaction and transaction engagement. The uncategorized vendors, although do not receive the forwarded information from the server, may have access to the one or more sets of data along with the corresponding assigned category information saved in the server if they are not registered under an assigned category corresponding to the assigned category information.

Restriction can be set in the section of provider 122; for example, Service Request Intent would only shows Service Provider that the customer currently has product(s) (including asset) and/or service(s), with warranty and/or service agreement contract registered.

Section of Interaction and transaction 123, is the section that the customer can has messaging with one or more Vendor(s) and/or Service Provider(s), regarding the Intent.

In this section of interaction and transaction 123, the various paired Vendor(s) and/or Service Provider(s) could respond to the one or more sets of data sent by the customer by other one or more sets of data that include information of one or more of prices, delivery terms and conditions, service terms and conditions, warranty terms and conditions and/or extended service/warranty terms and conditions.

The customer selects a provider to establish the transaction from the one or more providers who have responded to the one or more sets of data and are registered under an assigned category corresponding to the assigned category information or from any provider who have responded to the one or more sets of data and is not registered under an assigned category corresponding to the assigned category information. Upon the customer's acceptance of the one or more sets of data that include information of one or more of prices, delivery terms and conditions, service terms conditions, warranty terms and conditions and/or extended service/warranty terms and conditions, the transaction is established between the customer and the selected provider.

For example, the customer's intent is an enquiry on a product, and with the image captured by apparatus's camera function and send to a category of vendors that sold that type of product, the various vendors from this category could opt to accept by offering a certain price for the product by selecting Option 139a or reject to respond by selecting Option 139b that would delete that customer's enquiry from that vendor's apparatus 130, that will update at the server 110. In FIG. 5, provider 1 and 2 are the vendors that responded, as shown in dialogue boxes (125, 126).

Likewise, the customer has selectable options (129a, 129b) to accept or reject the product with a certain price offer by the vendor(s). By accepting the Offer through selecting Option 129a, would proceed to mode of payment and delivery arrangement, while by rejecting the Offer through selecting Option 129b, would delete the respond of the vendor from the customer's apparatus 120 (assumed that it is stored in the customer's apparatus 120).

In the section of interaction and transaction 123, Confirmation check 124 is created and sends by the provider, for the customer to verify before approval. For example, the Optical character recognition (OCR) electronic conversion of warranty registration's photographed image may have inaccuracy that required verification and confirmation respond. The customer has selectable options to accept or reject the confirmation with additional comment.

Although apparatus 120 show section of customer intent with only two intents, section of provider with only two providers and section of interaction and transaction engagement with only two responds from provider 1 and 2, it is understandable that section of customer intent can have one or more intent(s), section of provider can have one or more provider(s), and section of interaction and transaction engagement can have one or more respond(s) from different or same provider(s).

Once a section has been selected, it can be enlarge to allow better view and access on that section from the customer's apparatus 120 and provider's apparatus 130 respectively. Numerous items in that section can be accessible by scrolling up or down within the section.

Furthermore, although one customer apparatus 120 and one provider apparatus 130 is shown in FIG. 5, in the actual disclosed system, it can have one or more customer(s) with their apparatus 120, and one or more provider(s) with their apparatus 130.

In FIG. 5, various sections of the disclosed system are also shown and used by the vendor/service provider from Apparatus 130 to respond and engaged with the customer.

Section of Customer Intent 131, is the selectable section that shows all the intent(s) send by one or more customer(s) to the provider. The intent could be an Enquiry, Warranty/Service Agreement Registration, Service Request, Feedback or any other Intent that the customer(s) would like to find out and/or required action from the Provider. In this section of Customer Intent 131, the Provider could choose whether to respond to the Customer's Intent.

For example, the Provider could opt to accept respond by selecting Option 139a to offer a certain price for the product that the customer enquires, or reject to respond by selecting Option 139b that would delete that customer's enquiry from that provider's apparatus 130, that would update to server 110.

Section of Product and Service 132, is the section that list the product(s) and service(s) that the provider is selling/leasing. The Provider could offer one or more Product(s) and/or Service(s) to one or more enquiry(s) from one or more customer(s).

For example, several customers has enquires about a certain product from the provider, and the provider could select all the enquiries about this product from the several customers in the section of Customer Intent 131, and offer them at a price for the product, that could be lower than the market price.

Section of interaction and transaction 133 from the provider's apparatus 130, would shows the dialogue box from the customer with selected Intent. In this section, the provider can have messaging with the customer who has the Intent selected by the provider. The product(s) and/or service(s) that the provider offer to the customer would appear in the dialogue box within section of interaction and transaction 133, so that the provider could know and keep track of what have been offer to that customer's enquiry.

Section of Provider Intent 134, is the selectable section that indicate what is the various options of Intent that the provider could communicate and engaged with customer, superior and external party(s). The intent could include Confirmation Check which is a form of Reporting, such as Service Report, prepared by the Service Personnel for the customer to verify before approval, and is not limited to the intent mentions.

FIG. 6 shows a second usage scenario.

System 200 includes one or more vendors that offer the category of product(s) (including asset(s)) and/or service(s) sought after by the customer. The customer can select one or more vendors for enquiry, and the customer can also select one or more categories of vendor(s) to broadcast the enquiry.

Each vendor can be included in one or more categories, by the product(s) and/or service(s) sell or lease, as well as location, and are not limited to the mention.

For example, such as a superstore that carried products from vast variety of categories, can be included in the Furniture, Computer, Stationery, Grocery, Toiletry and Delivery category et cetera, and has branches in different location.

Each Enquiry with a unique enquiry identification number can also include one or more product(s) (including asset(s)) and/or service(s) enquiries. For example, in the case of using superstore, one enquiry identification number could include enquiries on numerous grocery products.

Each Enquiry has an unique enquiry identification and can opt not to carry the customer information, so as to ensure that the customer information remains confidential during the stage of enquiry.

FIG. 6 also illustrates each Vendor can have one or more enquiry(s) from one or more customer(s). The enquiry can be send by the customer in the form of image(s), video(s), comment(s) or a combination of image(s) and/or video(s) with optional comment(s). The enquiries can be included in a single section or categorized into different sections, such as category of Furniture, Computer, Grocery, Vehicle, Property, Delivery et cetera, and is not limited to the categories mention.

Each vendor can select which product(s) (including asset(s)) and/or service(s) to offer to the customer based on the customer one or more enquiries.

The customer can select one or more enquiries before proceeding to sending the enquiry.

The vendor can download the enquiry(s) into an apparatus or uses the apparatus to login to the cloud server, in order to manage the customer(s) enquiry(s).

Although one vendor is shown in FIG. 6, system 200 can includes a plurality of vendors that offer the category of product(s) (including asset(s)) and/or service(s) sought after by the customer.

Apparatus 220 can be any devices, such as portable smart phone, tablet or laptop that the customer used to seek one or more enquiry(s) from one or more selected vendor(s). Apparatus 220 can also be used by the customer to broadcast to one or more category(s) of vendors that offer the product(s) (including asset(s)) and/or service(s) that the customer enquire.

For Example in FIG. 6, vendor 1 and vendor 2 within the Furniture Category 222a in the Section of Provider 222 are selected by the customer to receive the enquiry. The enquiry within the Section of Customer Intent 221 in FIG. 6 is in the form of the furniture's image 221a with optional comments 221b. Column 221d allow the customer to add another enquiry, and Selection options 221c, allow customer to choose which enquiry to further the action.

Once one or more enquiries are selected, the customer can select selectable option: Accept 229a to proceed with sending the Enquiry(s) through the Service Network to the Selected Vendor(s).

For Enquiry(s) that are no longer wanted by the customer, the one or more unwanted Enquiry(s) can be selected from Selection Options 221c to be remove from the Apparatus 220 and/or the Cloud Server, depend on where the Enquiries information are residing, by proceeding with selecting the selectable option: Reject 229b for removing the enquiry(s).

The selected vendor(s) can receive the enquiry(s) from Apparatus 230, by means of downloading the enquiry(s) to the Apparatus 230 or using the Apparatus 230 to login to the cloud server where the enquiry(s) information resides, in order to manage the customer enquiry(s). Apparatus 230 can be any devices, such as portable smart phone, tablet or laptop that the vendor used to manage one or more enquiry(s) from one or more customer(s).

For Example in FIG. 6, Vendor 1 has opted to respond to customer 1, by selecting customer 1's enquiry from the Selection Options 231c within the Section of Customer Intent 231. As customer 1's enquiry fall in the Furniture Category, the Furniture list 232a can appear in Apparatus 230 screen display. Alternatively, Vendor 1 could select Furniture category from the Section of Product and Service 232 in order for Furniture list 232a to appear in Apparatus 230 screen display.

Vendor 1 could choose which Furniture to offer to the customer, based on the customer's enquiry(s). In FIG. 6, furniture with dimension 16×15×10, at a price of $250 in the Furniture list 232a is chosen by Vendor 1 to match Customer 1's enquiry.

Options 239a and 239b can provide the vendor with selectable options to respond to the enquiry(s). There can be more or fewer options depending on the implementation. For example, vendor 1 can reject one or more selected Enquiry(s) from the Section of Customer Intent 231, by selecting the Selection Options 231c of the Enquiry(s) before proceeding to select Option 239b for removing the Enquiry information from the residing storage.

For Example in FIG. 6, vendor 1 has chosen furniture with dimension 16×15×10 in the Furniture list 232a to match the customer 1's enquiry, and could proceed with sending the information of Offer to customer 1 by selecting Option 239a.

In FIG. 6, the customer's apparatus display 2 shows the Section of Interaction and Transaction 223 display been maximized by selecting the Intent Identification number 221e.

In this example, Intent Identification number 221e: SQ01 has been selected, and it Section of Interaction and Transaction 223 has been maximized as shown in Customer's apparatus 220 display 2. (In order to switch back to display 1, what the customer needs to do is select the Intent Identification number 221e in display 2)

Customer 1 receiving respond of Offer from vendor 1 and vendor 2 can decide which vendor to respond. For Example, if the customer has decided to take up the first Offer from vendor 2, the customer could select Selection Option 224a in Vendor 2's Dialogue box 224, follow by Selection Option 229a to proceed to purchase payment.

With the Section of Interaction and Transaction Engagement 223 maximized, Options 229a and 229b can provide the customer with selectable options to respond to the Offer(s) from the Vendor(s). Option 229a is to accept Vendor(s) Offer and proceed with Purchase payment, while Option 229b is to reject Vendor(s) Offer that will remove that Vendor's Dialogue Section from the display and information storage. There can be more or fewer options depending on the implementation.

In FIG. 6, Customer 1 is interested with the Offer from Vendor 1, but would like to find out whether it include delivery, with Vendor 1 reply as No and counter offer with additional delivery charge of $15 that is lower than the market rate as part of the package offer, indicated in Vendor 1 Dialogue Box 225 of the Customer's apparatus 220.

Vendor 1 could select delivery charge from the Section of Product and Service 232, and resend the delivery Offer with the Product Offer already selected before proceeding to select 239a.

Customer 1 been satisfied could select the Selection Option 225a of the second offer, follow by selecting 229a to accept and proceed with the mode of payment.

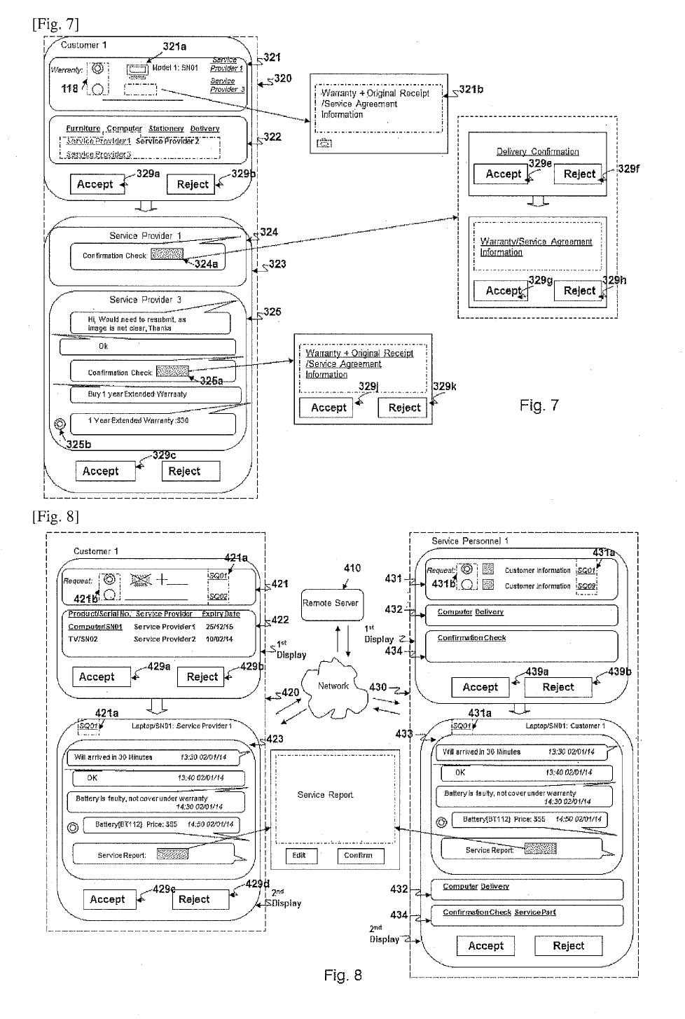

FIG. 7 illustrates a third usage scenario.

Warranty and Service agreement information is authenticated and control by the Remote Server via the Network.

As described above, the one or more sets of data from the customer can be a warranty request in respect of a product or a service.

Apparatus 320 can be any devices, such as portable smart phone, tablet or laptop that the customer used to register warranty(s) plus original receipt(s) and/or service agreement(s) with one or more Service Provider(s).

Information of warranty and service agreement that have expired could be removed from the residing storage by selecting Option 329b.

Product(s) (including asset(s)) and Service(s) purchase or leased using the disclosed system, would have the warranty information or the service agreement contract information generated into the Warranty Category in the Section of Customer Intent 321 by the remote server, once the payment is been made and the information is been captured in the remote server through the netword. Alternatively, parts or the entire of the warranty information or the service agreement information are already available at the point of establishing the transaction or closing the sales. In particular, the terms and conditions of the warranty information or the service agreement information are pre-uploaded to the system by the provider who offers the products and/or the services.

Upon delivery of the product 321a purchase using the disclosed system, customer 1 could go on to select Confirmation Check 324a from the Service Provider 1's Dialogue box 324 in the Section of Interaction and Transaction 323.

If the product delivered is in satisfactory condition, the customer could proceed to select Option 329e, to indicate to the Remote Server that the delivery has been accepted. Otherwise, the customer could select Option 329f to reject the delivery and indicate with Comments for the rejection to the Remote Server through the Service Network.

Within a specified duration, from the date of purchase, leased or delivery in which the product delivered has been accepted, the customer could verify the warranty or service agreement information and opt to accept by selecting Option 329g that would notify the Remote Server that the warranty or service agreement has been accepted by the customer. Otherwise, the customer could select Option 329h to notify the Remote Server that it is been rejected with given comments to indicate the reason for the rejection.

All accepted warranty and service agreement using the disclosed system would be control and authenticated by the Remote Server through the Network. The customer's accepted warranty and/or service agreement would be registered in the server and generated into the Service Request Intent's Section of Provider 322.

Registering a warranty and/or service agreement comprises receiving the warranty and/or service agreement information at the server from the provider; pairing the warranty and/or service agreement information to the customer in accordance with the stored customer's information and the stored information of the transaction of the one or more product or one or more service; authenticating the warranty and/or service agreement information, wherein the authenticating comprises sending a confirmation check including the received warranty information to the customer and wherein the warranty and/or service agreement information comprises one or more of terms and conditions of assurance for the one or more products or one or more services of the transaction; and completing the registering once the confirmation check is accepted by the customer.

The warranty and/or service agreement information submitted to the server could be the Product Brand, Model and Serial number, while the terms and conditions of the warranty and/or service agreement could already be uploaded to the Server by the provider before the transaction.

The warranty and/or service agreement information submitted to the server could be in the form of a captured image.

For products that are purchased through the present system, the captured image can be in the form of image code that identifies the Product's Brand, Model and Serial Number which would pair with its terms and conditions pre-uploaded to the server by the provider, who can be a manufacturer or a service provider, plus purchase evidence, such as a receipt.

For products that are not purchased through the present system, the captured image could include terms and conditions.

As an advantage, the provider could keep track of the number of warranty/service agreement from the system via the apparatus that are committed to fulfill, as well as an option to proposed to customer of their product/service for warranty/service agreement extension.

Only Service Provider(s) in which customer has warranty(s) or service agreement(s) registered as described herein, will appear in the Section of Provider 322. All rejected warranty and service agreement by the customer would be investigated by the respective provider, e.g. a vendor who offers the products and/or services, as they are notified by the disclosed system. The vendor can be a manufacturer or a service provider.

For service purchased or leased that does not have any date of delivery, the customer would just need to select Option 329g that would notify the Remote Server that the service agreement has been accepted by the customer. Otherwise, the customer could select Option 329h to notify the Remote Server that it is been rejected with given comments to indicate the reason for the rejection.

In situation, where the Product(s) (including asset(s)) and Service(s) is not purchased or leased through the system, the customer could capture the image(s) of the (warranty information plus original receipt or service agreement information) 321b and submit to the Remote Server through the Network by selecting Option 329a. The warranty information and the service agreement information submitted to the Remote Server may include information of terms and conditions.

The Service Personnel managing the Remote Server platform for the Service Provider, would message the customer, such as in FIG. 7, Service Provider 3 could inform customer 1 that the submitted image(s) is not clear and would require resubmission from the Dialogue Box in the Section of Interaction and Transaction 323.

The customer 1 could follows the instruction to recapture the image(s) of the (warranty information plus original receipt or service agreement information) 321b and resubmitting to the Remote Server through the Network by selecting Option 329a again.

Once the Remote Server has receive the image(s) of the (warranty information plus original receipt or service agreement information) 321b that is satisfied, would send a notification in the form of Confirmation Check 325a, whereby the customer could verify the information and select Option 329j to notify the Remote Server, if the information is correct, or select Option 329k to notify the Remote Server, if the information is found to be incorrect.

Through the Dialogue Box 325, customer 1 could enquires from Service Provider 3, such as Extended Warranty and Service Provider 3 could offer the Extended Warranty, where the customer could decide to accept by selecting Option 325b, follow by Option 329c to proceed to the mode of payment for Extended Warranty.

As the Warranty and the Service agreement contract information is centrally controlled by the Remote Server, upon closed to the date of expiry or been expired, there will be notification alert send to the customer's apparatus and/or service provider's apparatus.

The interested provider(s) (vendor(s) and/or service provider(s)) could offer to extended the warranty or service agreement with a price or package, or offer other product(s) and/or service(s) for the customer consideration and eventual purchase or lease.

FIG. 8 illustrates a fourth usage scenario.

Apparatus 420 can be any devices, such as portable smart phone, tablet or laptop that the customer used to seek one or more Service Request(s) from one or more Service Provider(s). Apparatus 430 can be any devices, such as portable smart phone, tablet or laptop that the service provider used to reply and correspond to one or more Service Request(s) from one or more customer(s).

Service Request(s) can be created in the Section of Customer Intent 421 in the form of image(s), video(s) or a combination of image(s) and/or video(s) with optional comment(s).

Only Service Provider(s) in which customer has warranty(s) or service agreement(s) registered with the disclosed system, will appear in the Section of Provider 422

Within the Section of Provider 422, important service information such as Product Model number, Serial number, Service Provider information, expiry date will appears and is not limited to those information mentions.

For example in FIG. 8, customer 1 has captured an image of the faulty personal computer using Apparatus 420. From the Section of Provider 422, customer 1 could select Product/Serial No.: Computer/SN01 as the target of the Service Request By selecting Option 429a would submit the Service Request, identify with a Service Request identification number of SQ01 to Service Provider 1 that is the Service Provider providing the service support for this faulty personal computer.

The service provider could reply and correspond to the customer's service request, such as the time of arrival, any additional charges for servicing and service report in the form of confirmation check et cetera, via Apparatus 430.

All the reply and correspondence between the customer and service provider will appear in the Section of Interaction and Transaction (423,433) of Apparatus 420 and 430.

Customer and Service Provider could switch their apparatus between 1st display to 2nd display, by simply selecting Service Request identification number (421a for Apparatus 420 and 431a for Apparatus 430).

In the process of service, if the service personnel find a part that requires replacement and is not cover under the warrant or service agreement, would use Apparatus 430 to send the part offer to the customer, and the customer could choose to accept the offer by selecting Option 429c to proceed to the mode of payment.

Whether it is before, in the process or after servicing, the service personnel could use Confirmation check in the section of Provider intent 434 to create Service Report, whereby the order of service part could be done through the service report electronically, as the service report has a portion that allow the service personnel to order the part(s) and the status of the part could appear in the service report. This is to avoid floating service part stock that can eventually be unaccounted for.

In another embodiment, the spare part would appear in the section of Provider intent 434 for the service personnel to order electronically through the apparatus 430.

At any stage, the service personnel could send the Service Report to the customer as Confirmation check, whereby the customer can verify, edit and input comment, as well as to confirm to close the service request permanently or temporarily.

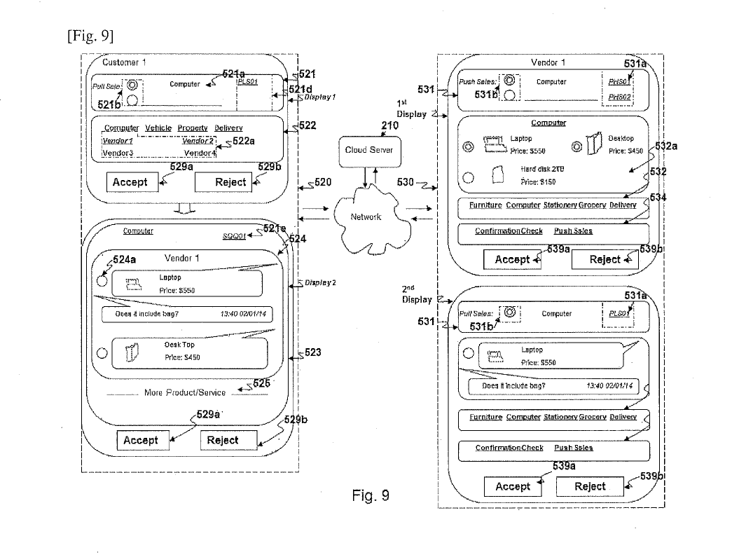

FIG. 9 illustrates a fifth usage scenario.

Apparatus 520 can be any devices, such as portable smart phone, tablet or laptop that the customer used to seek Pull Sales from one or more Vendor(s) or Category(s) of Vendors. Apparatus 530 can be any devices, such as portable smart phone, tablet or laptop that the vendor used to Push Sales to the Remote Server to be view by customer from their apparatus 520.

Push Sales is the method that the Vendor use to send a group of their product(s) and/or service(s) information to the remote server, for customer(s) that could be interested to buy from that group of product(s) and/or service(s) to retrieve the information into their apparatus 520.

Pull Sales is the method that the Customers used to retrieve a group of product(s) and/or service(s) that they could be interested of buying or leasing from the remote server to their apparatus 520, and appear in the Section of Interaction and Transaction 523.

The customer could select one or more Vendor(s) or Category(s) of Vendors for Pull Sales. In the customer's Section of Interaction and Transaction 523, the group of product(s) and/or service(s) could be view by the customer and if the customer would want to find out additional information about a particular product(s) and/or service(s), can input their question into the callout box or space below it and the information can be send to the vendor to reply with selectable Option(s).

There shall be Option at the bottom of the Section of Interaction and Transaction that would allow the customer to pull more product(s) and/or service(s) information to the Apparatus 520 from the Remote Server through the Network.

Therefore the Section of Interaction and Transaction in the disclosed system, is the section that customer and provider could have messaging conversation, as well as all other activities, such as browsing of product(s) and/or service(s), notification and confirmation check, viewing of detail information and purchase or leasing transaction etc. and is not limited the activities mention.

Considering the size of product(s) and/or Service(s) image(s)/video(s) to be big, the product(s) and/or Service(s) information (such as document, image(s) and/or video(s)) will be transmit to the customer apparatus in sample size; only when the customer select the information (such as the document, image(s) and/or video(s)), the actual size information would be downloaded to their apparatus, in this disclosed system.

Vendor could select Push Sales from the Section of Provider Intent, and the Push Sales request would appear in the Section of Customer Intent. Every Push Sales has a Push Sales Identification number. Vendor could select from the Section of Product and Service for the category(s) of Product(s) and/or Service(s) to be uploaded to the remote server for customer to retrieve.

Once all the Product(s) and Service(s) that the Vendor intended to put into the particular Push Sales has been selected, could proceed to Select Option 539a to transmit the information to the Remote Server.

Customer who is interested to look through the product on offer could select Pull Sale from the Section of Customer Intent 521 and select the category of product(s) and/or service(s) to be retrieve to the apparatus 520.

Customer could select a particular vendor for pull sales or category(s) for pull sales, and proceeding to selecting Option 529a to accept retrieval of pull sales information.

Section of Interaction and Transaction 523 will allow customer to browse through the product(s) and/or service(s) on offer. Customer could send query(s) to the vendor for the particular product(s) and/or service(s) interested.

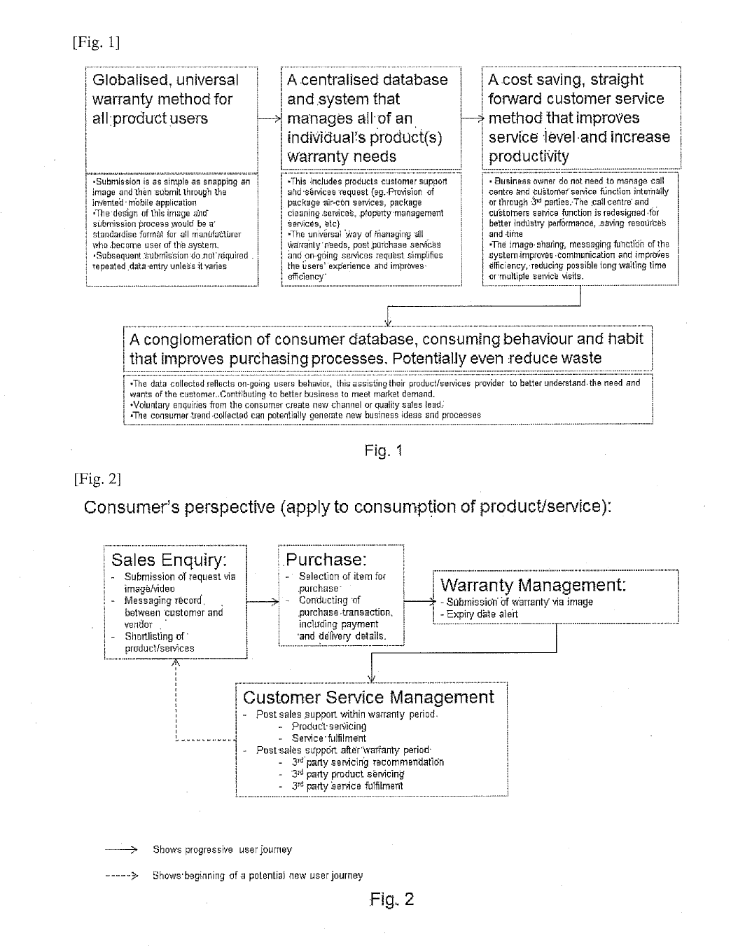

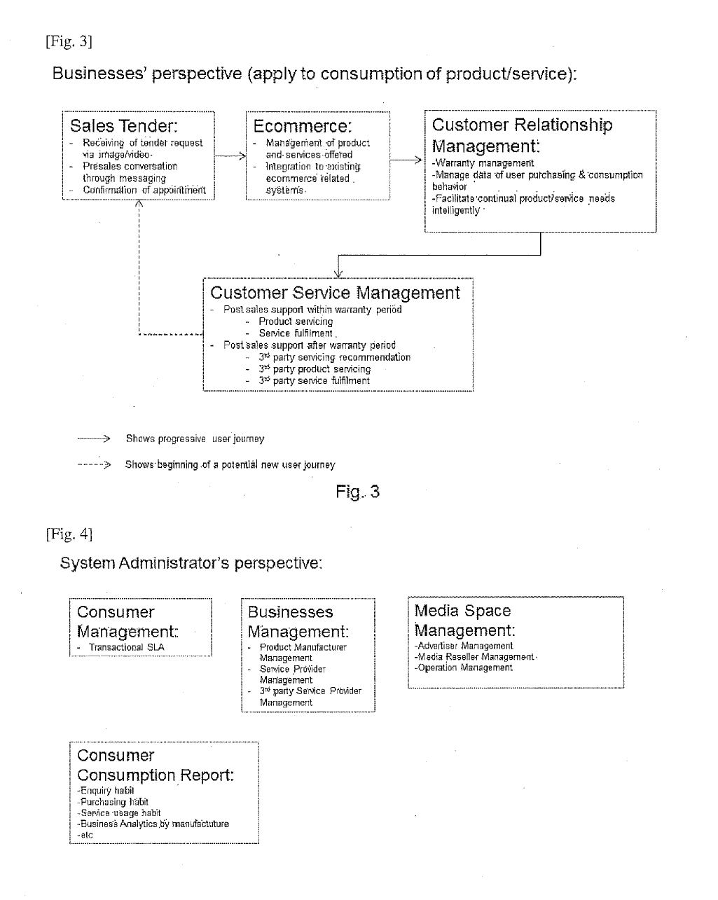

Finally, FIGS. 1 to 4 provide overviews of the present invention, the figures themselves including adequate information for understanding the figures.

It should further be appreciated that the exemplary embodiments are only examples, and are not intended to limit the scope, applicability, operation, or configuration of the invention in any way. Rather, the foregoing detailed description will provide those skilled in the art with a convenient road map for implementing an exemplary embodiment of the invention, it being understood that various changes may be made in the function and arrangement of elements and method of operation described in an exemplary embodiment without departing from the scope of the invention as set forth in the appended claims.

1. A method for dynamic customer/provider data pairing, the method comprising:
receiving one or more sets of data from a customer;
processing the one or more sets of data from the customer, wherein the one or more sets of data is each dynamically assigned with category information, and wherein the processing comprises saving the one or more sets of data along with the corresponding assigned category information in a server;
forwarding the one or more sets of data to one or more providers that are registered under an assigned category corresponding to the assigned category information; and
responding to the customer with other one or more sets of data from the one or more providers.

2. The method in accordance with claim 1, wherein the one or more sets of data along with the assigned category information saved in the server are accessible along with other one or more sets of data by any provider that is not registered under an assigned category corresponding to the assigned category information.

3. The method in accordance with claim 1, wherein the other one or more sets of data, from the one or more providers that are registered under an assigned category corresponding to the assigned category information or from any provider that is not registered under an assigned category corresponding to the assigned category information, comprise one or more of prices, delivery terms and conditions, service terms conditions, warranty terms and conditions and/or extended service/warranty terms and conditions.

4. The method in accordance with claim 1, wherein one set of the one or more sets of data from the customer is in relation to an enquiry to establish a transaction in respect of one or more products or one or more services or an after service request in respect of one or more products or one or more services.

5. (canceled)

6. The method in accordance with claim 5, wherein the one set of the one or more sets of data from the customer is received in a form of a captured image or video of the one or more products or one or more services.

7. The method in accordance with claim 4, further comprising the customer selecting a provider from providers who have responded to the one or more sets of data with the other one or more sets of data, such that the transaction is established between the customer and the selected provider.

8. The method in accordance with claim 7, further comprising storing the customer's information, the selected provider's information, and the information of the one or more product or one or more service at the server.

9. The method in accordance with claim 8, wherein the information of the one or more product or one or more service comprises one or more identifying details including product name, product model, brand, serial number, receipt information or dimension details, and wherein the one or more product comprises a property, the information of the one or more product comprises one or more address, block number or unit number.

10. (canceled)

11. (canceled)

12. The method in accordance with claim 8, further comprising registering warranty information associated with the transaction of the one or more product or one or more service, wherein the registering comprises:
receiving the warranty information at the server from the provider;
pairing the warranty information to the customer in accordance with the stored customer's information and the stored information of the transaction of the one or more product or one or more service;
authenticating the warranty information, wherein the authenticating comprises sending a confirmation check including the received warranty information to the customer and wherein the warranty information comprises one or more of terms and conditions of assurance for the one or more products or one or more services of the transaction; and
completing the registering once the confirmation check is accepted by the customer.

13. (canceled)

14. The method in accordance with claim 9, wherein the information of the transaction of the one or more product or one or more service and the warranty information are submitted in a form of a captured image.

15. (canceled)

16. (canceled)

17. The method in accordance with claim 8, further comprising:
receiving at the server an after service request in respect of the one or more product or one or more service purchased via the transaction;
pairing at the server of the after service request with the warranty information registered in the server and the selected provider's information stored in the server in accordance with the information of the one or more product or one or more service; and
showing the registered warranty information and the stored selected provider's information to the customer.

18. The method in accordance with claim 17, wherein the one set of the one or more sets of data from the customer is submitted in a form of a captured image or video of the one or more product or one or more service.

19. The method in accordance with claim 17, further comprising the customer selecting the stored selected provider, whereby the server forwards the after service request to the stored selected provider.

20. (canceled)

21. (canceled)

22. A server for an intermediary that transmits one or more data between customers and providers, the one or more data was assigned with category information enabling dynamic customer/provider data pairing, the intermediary server comprising:
at least one processor; and
at least one memory including computer program code;
the at least one memory and the computer program code configured to, with the at least one processor, cause the intermediary server at least to:
receive one or more sets of data from a customer;
process the one or more sets of data from the customer; and
wherein the one or more sets of data is each dynamically assigned with category information, and wherein the processing comprises saving the one or more sets of data along with the corresponding category information;
forward the one or more sets of data to one or more providers that are registered under an assigned category corresponding to the assigned category information; and
respond to the customer with other one or more sets of data from the one or more providers.

23. The server in accordance with claim 22, wherein the one or more sets of data along with the assigned category information saved in the server are accessible along with other one or more sets of data by any provider that is not registered under an assigned set of category corresponding to the assigned category information.

24. The server in accordance with claim 22, wherein one set of the one or more sets of data from the customer is received in a form of a captured image or video of the one or more products or one or more services.

25. The server in accordance with claim 22, further comprising the customer selects a provider from providers who have responded to the one or more sets of data with the other one or more sets of data, such that the transaction is established between the customer and the selected provider.

26. The server in accordance with claim 22, wherein one set of the one or more sets of data from the customer is in relation to an enquiry to establish a transaction in respect of one or more products or one or more services, and wherein the server is further caused to register warranty information associated with the transaction of the one or more product or one or more service, wherein the registering comprises:
receiving the warranty information at the server from the provider;
pairing the warranty information to the customer in accordance with the stored customer's information and the stored information of the transaction of the one or more product or one or more service;
authenticating the warranty information, wherein the authenticating comprises sending a confirmation check including the received warranty information to the customer and wherein the warranty information comprises one or more of terms and conditions of assurance for the one or more products or one or more of services of the transaction; and
completing the registering once the confirmation check is accepted by the customer.

27. The server in accordance with claim 26, wherein the information of the transaction of the one or more product or one or more service and the warranty information are submitted in a form of a captured image.

28. The server in accordance with claim 26, wherein the server is further caused to:
receive at the server an after service request in respect of the one or more product or one or more service purchased via the transaction;
pair at the server of the after service request with the warranty information registered in the server and the selected provider's information stored in the server in accordance with the information of the one or more product or one or more service, and
show the registered warranty information and the stored selected provider's information to the customer.

29. The server in accordance with claim 28, wherein the one set of the one or more sets of data from the customer is submitted in a form of a captured image or video.

30. The server in accordance with claim 28, wherein the customer selects the stored selected provider, whereby the server forwards the after service request to the stored selected provider.

31. (canceled)

32. A system for customer warranty management and after service support, the system comprising:
a server for an intermediary that transmits data between one or more customers and one or more providers, and stores data received as one or more sets of data from the one or more customers;
one or more customer apparatus for the one or more customers to send the one or more sets of data to the server, wherein the one or more sets of data comprise customer warranty information; and
one or more provider apparatus for one and more providers to receive the one or more sets of data and respond to the server with other one or more sets of data,
wherein the one or more sets of data further comprise after service requests in relation to one or more products or services, wherein the server checks the customer warranty information and service provider information registered in the server under the customer for pairing with the one or more products or services,
wherein when the one or more products or services are not paired with one or more registered warranty information and service provider information, the server dynamically assigns category information to the after service request and saves the one or more sets of data of the after service request along with the corresponding assigned category information,
wherein the server forwards the one or more sets of data to the one or more providers that are registered under an assigned category corresponding to the assigned category information,
wherein the one or more providers respond to the one or more customer via the server,
wherein when the one or more products or services are paired with one or more registered warranty information and service provider information, the after service request is within the validity period of the registered warranty,
wherein the server forwards the one or more sets of data of the after service request to the one or more registered service provider, and
wherein the one or more registered service provider responds to the one or more customer with the other one or more sets of data of the after service request via the server.

33. The system in accordance with claim 32, wherein the one or more sets of data comprising the customer warranty information and/or the after service requests are in a form of a captured image or video.

34. The system in accordance with claim 32, wherein the one or more products or services are paired with one or more registered warranty information and service provider information, and wherein the after service request is not within the validity period of the registered warranty,
wherein the server forwards the one or more sets of data of the after service request to the one or more registered service provider, and dynamically assigns category information to the after service request and saves the one or more sets of data of the after service request along with the corresponding assigned category information, and wherein the server forwards the one or more sets of data to one or more providers that are registered under an assigned category corresponding to the assigned category information, and
wherein the registered service provider and the one or more providers that are registered under an assigned category corresponding to the assigned category information respond to the one or more customers with the other one or more sets of data of the after service request via the server.

35. The system in accordance with claim 32, wherein the one or more sets of data along with the assigned category information saved in the server are accessible along with other one or more sets of data by any service provider that is not registered under an assigned category corresponding to the assigned category information.
